(19) United States
(12) Patent Application Publication
(10) Pub. No.: US 2026/0113237 A1
(43) Pub. Date: Apr. 23, 2026

(54) NETWORK CONFIGURATION WITH SELF-RECOVERY MECHANISM FOR CLOUD PLATFORM NODES

(71) Applicant: Dell Products L.P., Round Rock, TX (US)

(72) Inventors: Rui JIANG, Shanghai (CN); Zhang FLAG, Shanghai (CN); Shuang ZHENG, Shanghai (CN)

(73) Assignee: Dell Products L.P., Round Rock, TX (US)

(21) Appl. No.: 18/934,567

(22) Filed: Nov. 1, 2024

(30) Foreign Application Priority Data
Oct. 22, 2024 (CN) 202411481929.0

(51) Int. Cl. H04L 41/0813; H04L 41/0859

(52) U.S. Cl. CPC H04L 41/0813; H04L 41/0859

(57) ABSTRACT

Disclosed systems and methods for network configuration management in a cloud platform provisioned with a cloud platform manager (CPM) and a plurality of host nodes managed by the CPM include establishing an original configuration connection (OCC) with a host node to trigger a network configuration task for the host node. Upon receiving a task identifier (ID) assigned to a network configuration task, a new configuration connection (NCC) status query may be sent to the host node to monitor a status of the task. Responsive to detecting a status of completed for the network configuration task, a confirmation is sent to the host node. If acknowledgement of the confirmation is received, a notification indicating configuration of the new network configuration is recorded.

### TECHNICAL FIELD

The present disclosure pertains to cloud computing and, more specifically, management of cloud computing node configuration.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems may provide compute, storage, and networking infrastructure for public, private, and hybrid cloud computing solutions. In at least some cloud computing environments, inter-node topologies between different nodes are becoming increasingly more complex and public cloud customers have increasingly more specific and challenging network design requirements. Generally, complex network topologies present management and reliability challenges within existing cloud computing solutions. If a customer's cloud resources experience connection disruption, the customer must allocate valuable time and resources to troubleshoot and recover the network configuration of a potentially large number of nodes.

### SUMMARY

Common problems associated with managing node network configuration are addressed herein by disclosed systems and methods enabling reliable deployment and management of cloud computing node network configuration with self-recovery.

Disclosed features address inherent complexities of network configuration across diverse cloud environments, ensuring reliability, integrity and optimal performance.

In at least some embodiments, disclosed systems and methods employ a cloud platform manager (CPM) running on a primary node to provide services to customers and a node agent running on the operating system (OS) of each physical node allocated to the customer to provide services to the CPM. The CPM may trigger or otherwise initiate a network configuration task pertaining to a network configuration parameter including, as non-limiting examples, IP/netmask, gateway, maximum transmission unit (MTU), virtual local area network identifier (VLAN ID), physical network interface card (NIC), and the like. The CPM may broadcast the task in parallel to each node agent. Each node agent receiving or otherwise detecting the task may return an acknowledgement with a node-assigned task identifier (ID) to the CPM.

In at least some embodiments, the node agent triggers or otherwise initiates a task runner configured to execute as a background process that performs operations in support of the network configuration task. In at least some embodiments, the task runner records network configuration information to preserve the original network configuration, i.e., the network configuration state at the point in time when the task request was detected. In addition, the task runner may perform the actual configuration of the node network in accordance with the task, update a task status, start a timer, and wait for confirmation from the CPM.

Upon detecting the task ID from the node agent, the CPM may connect to the host via the new network and periodically query for task status subject to expiration of a timeout interval. If the CPM detects a completed status for the task, the CPM may send a confirmation to the node agent. In at least one embodiment, upon receiving confirmation from the CPM, the node agent may return an acknowledgement and cancel, disable, or otherwise prevent a passive rollback routine from being launched or otherwise executed. The CPM will update the task status for the applicable node.

If the agent cannot receive confirmation in a certain time, it will roll back the network to original network and actively stop the background task runner. When the CPM detects a partial node passive rollback, it will notify the remaining nodes to do active rollback. The CPM may also notify the user of the new network on which the node is failed.

In one aspect, disclosed systems and methods for network configuration management in a cloud platform provisioned with a cloud platform manager (CPM) and a plurality of host nodes managed by the CPM include establishing an original configuration connection (OCC) with a host node to trigger a network configuration task for the host node. Upon receiving a task identifier (ID) assigned to a network configuration task, a new configuration connection (NCC) status query may be sent to the host node to monitor a status of the task. Responsive to detecting a status of “completed” for the network configuration task, a confirmation is sent to the host node. If acknowledgement of the confirmation is received, a notification indicating configuration of the new network configuration is recorded.

If a host node returns a status of “failed” in reply to the NCC status query for the network configuration task, a confirmation may be sent to the node agent. Upon receiving an acknowledgement of the confirmation from the node agent, the CPM may trigger an active rollback task for the host node to restore the original network configuration to the host node. In at least some embodiments, the active rollback includes sending an OCC status query for the active rollback task to the host and, responsive to detecting successful completion of the rollback task, recording a status of failed for the network configuration task and successful restoration of the original network configuration.

If the host node does not return a status of the network configuration task before a timeout interval expires, an NCC node agent information query may be sent to the host node. Responsive to detecting the node agent information as successfully returned, the CPM may record a status of “failed” for the network configuration task and the successful restoration of the original network configuration.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 depicts a representative cloud platform in accordance with disclosed subject matter;

FIG. 2 depict a flow diagram of disclosed cloud platform management methods;

FIGS. 3, 4, 5 illustrate sequence diagrams for three cloud platform, network configuration scenarios; and

FIG. 6 illustrates an exemplary information handling system suitable for use in conjunction with subject matter illustrated in FIGS. 1-5 and described in the accompanying description.

### DETAILED DESCRIPTION

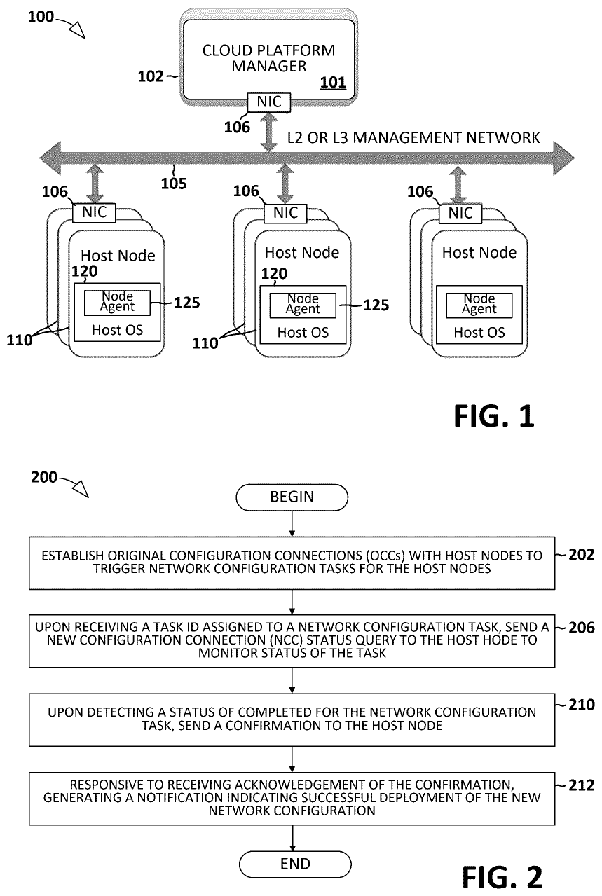

Exemplary embodiments and their advantages are best understood by reference to FIGS. 1-6, wherein like numbers are used to indicate like and corresponding parts unless expressly indicated otherwise.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”), microcontroller, or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

Additionally, an information handling system may include firmware for controlling and/or communicating with, for example, hard drives, network circuitry, memory devices, I/O devices, and other peripheral devices. For example, the hypervisor and/or other components may comprise firmware. As used in this disclosure, firmware includes software embedded in an information handling system component used to perform predefined tasks. Firmware is commonly stored in non-volatile memory, or memory that does not lose stored data upon the loss of power. In certain embodiments, firmware associated with an information handling system component is stored in non-volatile memory that is accessible to one or more information handling system components. In the same or alternative embodiments, firmware associated with an information handling system component is stored in non-volatile memory that is dedicated to and comprises part of that component.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems (BIOSs), buses, memories, I/O devices and/or interfaces, storage resources, network interfaces, motherboards, and/or any other components and/or elements of an information handling system.

In the following description, details are set forth by way of example to facilitate discussion of the disclosed subject matter. It should be apparent to a person of ordinary skill in the field, however, that the disclosed embodiments are exemplary and not exhaustive of all possible embodiments.

Throughout this disclosure, a hyphenated form of a reference numeral refers to a specific instance of an element and the un-hyphenated form of the reference numeral refers to the element generically. Thus, for example, “device 12-1” refers to an instance of a device class, which may be referred to collectively as “devices 12” and any one of which may be referred to generically as “a device 12”.

As used herein, when two or more elements are referred to as “coupled” to one another, such term indicates that such two or more elements are in electronic communication, mechanical communication, including thermal and fluidic communication, thermal, communication or mechanical communication, as applicable, whether connected indirectly or directly, with or without intervening elements.

Referring now to the drawings, FIG. 1 depicts a representative cloud platform 100 suitable for use in conjunction with cloud platform management features disclosed herein is depicted. The cloud platform 100 of FIG. 1 includes a cloud platform manager (CPM) 101 running on a primary node 102 and a two or more managed nodes referred to herein as host nodes 110. In at least some embodiments, each host node 110 corresponds to a physical node resource, e.g., a server-class information handling system, a hyperconverged infrastructure appliance, or the like. As depicted in FIG. 1, each host node 110 implements a host operating system (OS) 120 and a node agent 125 running in the host OS 120. Node agents 125 may be provisioned to enable, perform, and/or support one or more disclosed network configuration management features. In some embodiments, host nodes 110 may comprise a heterogeneous group of host nodes including one or more computer nodes, one or more storage nodes, one or more converged infrastructure nodes, etc. As depicted in FIG. 1, CPM 101 is communicatively coupled to host nodes 110 via a management network 105 and various network interface cards (NICs) 106. The management network 105 may be implemented with a level 2 (L2) or level 3 (L3) topology.

Referring now to FIG. 2, an exemplary method 200 for managing network configuration in a cloud platform, such as the cloud platform 100 of FIG. 1, is depicted. In at least one embodiment, the operations 202-212 included in method 200 refer to operations performed by a CPM, such as the cloud platform manger 101 of FIG. 1.

In the first operation of the depicted method 200, the CPM establishes (operation 202) an original configuration connection (OCC) to the host nodes to trigger a network configuration task for the host nodes. As used herein, an OCC refers to a network connection in accordance with an original network configuration, i.e., an original set of values for one or more network configuration settings, attributes, and the like. Representative network configuration attributes and settings include IP/netmask, gateway information, MTU, VLAN ID, physical NIC and other settings and attributes that those of ordinary skill will recognize as applicable. In at least some embodiments, the network configuration task is a network configuration change task to change the configuration of the host node's management network from the original network configuration to a new network configuration.

In response to the trigger, the host agent running in the host OS may launch a task runner or otherwise take action to perform and complete the task, assign a task ID to the task, maintain a task state attribute indicative of a state of one or more attributes of the task including a completion state attribute indicative of a completion state of the task, and return an acknowledgement of the trigger, including the task ID, to the CPM.

Upon receiving a task ID from a node agent, the CPM may send (operation 206) a new configuration connection (NCC) status query to the host node to monitor, for example, a completion status of the network configuration task. The query is referred to as an NCC status query to convey that the query is formatted and transmitted in accordance with the new network configuration. The NCC status query may be sent periodically until the CPM detects a completed status or a timeout exception is raised.

If the node agent successfully completes the network configuration task before a timeout interval expires, the node will have updated that task status to indicate completion of the task and the status query response will inform the CPM of the task's completion. Responsive to detecting a status of “completed” for the network configuration task, the COMP may send (operation 210) a confirmation to the host node. Upon receiving acknowledgment of the confirmation, the CPM may update (operation 212) the status of a CPM task associated with the network configuration task. The CPM may also broadcast, publish, or distribute, to each host node, an indication that the new network configuration has been successfully implemented.

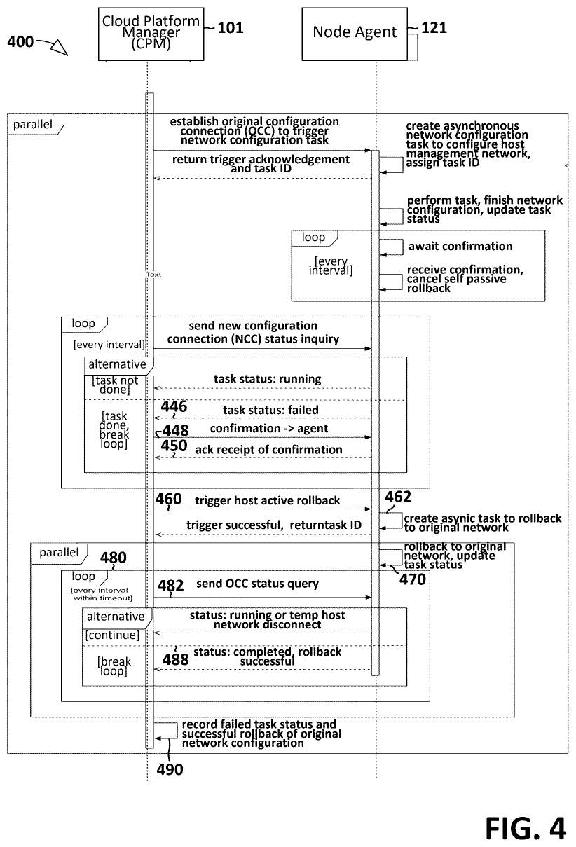

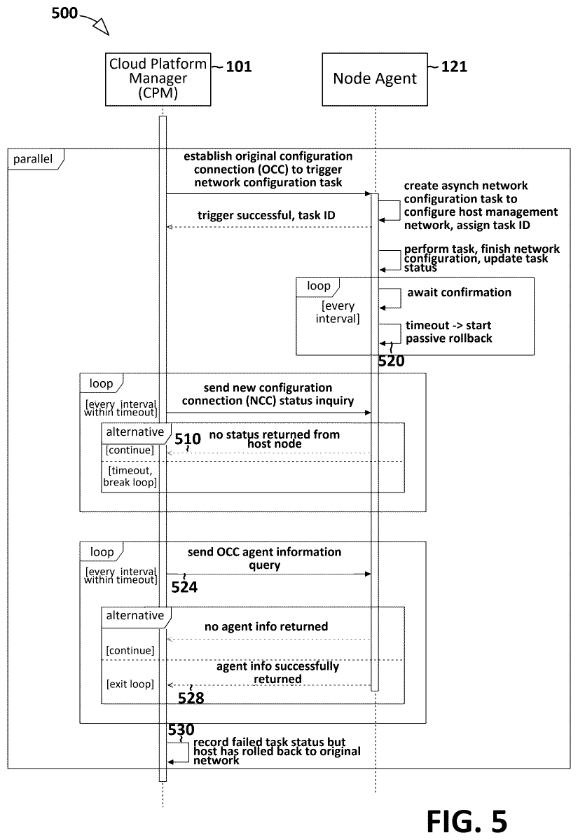

FIG. 2 does not expressly indicate operations associated with event sequences in which the new network configuration does not complete successfully. Examples of such sequences are illustrated in FIG. 4 and FIG. 5 and described in the accompanying text. It will be apparent to those of ordinary skill in the art that the operations illustrated in FIG. 4 and FIG. 5 may be incorporated into the network configuration management method disclosed herein. In this respect, FIG. 2 depicts some, but not necessarily all operations that may be included within the network configuration management method.

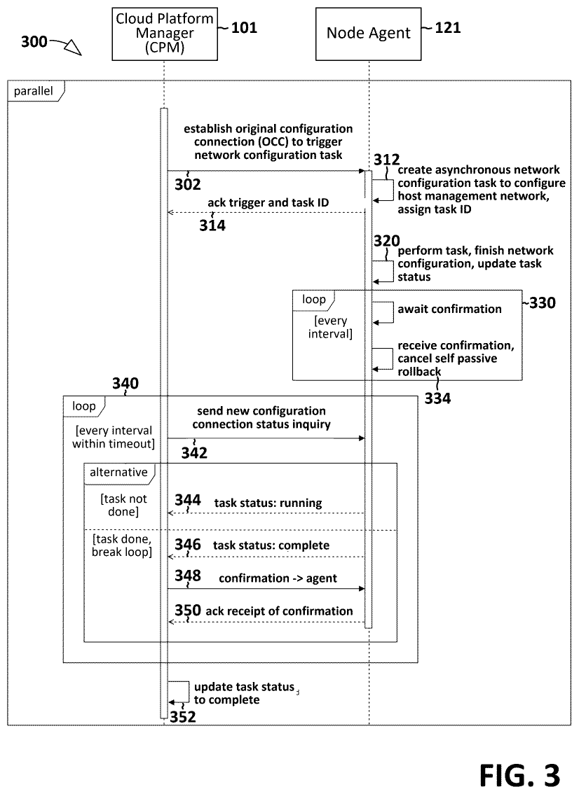

FIGS. 3, 4, and 5 illustrate sequence diagrams corresponding to three representative outcomes of the previously discussed network configuration task referenced in FIG. 2. The illustrated sequence diagrams include various iteration loops including parallel loops representing action performed by one or more actors simultaneously or substantially simultaneously and alternative iteration loops indicating two or more possible execution loops and conditions for determine which execution loop to perform.

FIG. 3 illustrates a network configuration management sequence 300 for an unconditionally successful outcome in which the node agents complete their tasks successfully and the CPM is able to detect and confirm successful task completion with each node agent. The sequences illustrated in FIGS. 4 and 5 depict sequences in which the network configuration task does not complete successfully but the platform successfully rolled back the network configuration to the original network configuration.

The sequence diagrams in FIGS. 3, 4, and 5 all illustrate a sequence of operations and interactions between CPM 101 and node agent 125. For the sake of simplicity, clarity and brevity, FIGS. 3, 4, and 5 illustrate a single node agent. Those of ordinary skill in the field of platform management, however, will recognize that CPM 101 may interact with multiple node agents 125 and that one or more interactions between CPM 101 and a node agent 125 may represent multiple interactions, performed in parallel between CPM 101 and all or some of the node agents 125.

FIG. 3 illustrates a representative sequence 300 of network configuration management operations in which a network configuration management task, triggered when CPM 101 connects to node agent 125, completes successfully, causing a change in the management network configuration of cloud platform 100.

The illustrated sequence 300 begins with cloud platform manager 101 establishing (302) an OCC connection to host node 110 to trigger a network configuration task for node agent 125. Node agent 125 detects and responds to the trigger by creating (312) an asynchronous network configuration task to configure the host's management network and assign a task ID to the task. Node agent 125 may then return (314) an acknowledgement and the task ID to CPM 110.

As further depicted in FIG. 3, node agent 125 may perform (320), e.g., launch a background task runner to perform, the network configuration task to effect the corresponding network configuration change, and update the task status attribute to indicate a completed status. Node agent 125 may then enter a confirmation loop 330 in which node agent 125 awaits a confirmation from CPM 101. Upon receiving confirmation from CPM 101, node agent 125 may cancel, disable, or otherwise prohibit (334) a network configuration rollback sequence referred to herein as the passive rollback.

As further depicted in FIG. 3, CPM 101 enters a status polling loop (340) and periodically sends (342) an NCC status query to node agent 125. As depicted in FIG. 3, if a status query reply 344 returned to CPM 101 indicates the task is still running or incomplete, CPM 101 takes no action and remains within polling loop 340. If a status query reply (346) returned to CPM 101 indicates the task is completed, CPM 101 sends a confirmation (348) to node agent 125 and the node agent 125 returns an acknowledgement 350 to CPM 101.

CPM 101 may then exit polling loop 340 and update (352) a manager-owned task status attribute to indicate a completed status. At this point, the management network 105 (FIG. 1) for cloud platform 100 has been changed from the original network configuration to the new network configuration.

Referring now to FIG. 4, the illustrated sequence 400 behaves like the sequence 300 of FIG. 3 until CPM 101 (446) receives a task status of failed. As depicted in FIG. 4, cloud platform manager 101 sends (448) confirmation of the failed task status to the node agent. Upon receiving (450) an acknowledgment from the node agent of the confirmation, cloud platform manager 101 triggers (460) a host active rollback task for the node agent. The node agent, upon receiving the rollback task, creates (462) an asynchronous task to roll back its network configuration to the original network configuration. Node agent acknowledges the task back to cloud platform manager 101, along with a task identifier corresponding to the task depicted it in FIG. 4, node agent will roll back (470) to the original configuration and updates the status to indicate completion of the task. The cloud platform manager 101 enters a status polling loop 480 and periodically sends (482) an original network connection query to the node agent. Upon determining (488) that the task status is completed, the cloud platform manager exits the loop, and records (490) a status of “failed” for the network configuration task, but successful rollback of the network configuration to the original network configuration.

Referring now to illustrated sequence 500 in FIG. 5, if the host node does not return a status of the network configuration task before a timeout interval expires (510), the node agent starts (520) a rollback to the original network configuration. The CPM sends (524) an OCC agent information query to the host node to confirm the function of the original network configuration. Responsive to detecting (528) node agent information successfully returned, the CPM may record (530) a status of failed for the network configuration task and the successful restoration of the original network configuration.

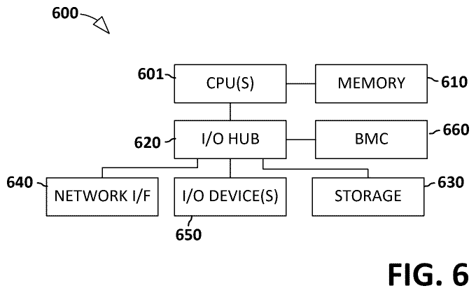

Referring now to FIG. 6, any one or more of the elements illustrated in FIG. 1 through FIG. 5 may be implemented as or within an information handling system exemplified by the information handling system 600 illustrated in FIG. 6. The illustrated information handling system includes one or more general purpose processors or central processing units (CPUs) 601 communicatively coupled to a memory resource 610 and to an input/output hub 620 to which various I/O resources and/or components are communicatively coupled. The I/O resources explicitly depicted in FIG. 6 include a network interface 640, commonly referred to as a NIC (network interface card), storage resources 630, and additional I/O devices, components, or resources 650 including as non-limiting examples, keyboards, mice, displays, printers, speakers, microphones, etc. The illustrated information handling system 600 includes a baseboard management controller (BMC) 660 providing, among other features and services, an out-of-band management resource which may be coupled to a management server (not depicted). In at least some embodiments, BMC 660 may manage information handling system 600 even when information handling system 600 is powered off or powered to a standby state. BMC 660 may include a processor, memory, an out-of-band network interface separate from and physically isolated from an in-band network interface of information handling system 600, and/or other embedded information handling resources. In certain embodiments, BMC 660 may include or may be an integral part of a remote access controller (e.g., a Dell Remote Access Controller or Integrated Dell Remote Access Controller) or a chassis management controller.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

What is claimed is:

1. A management method for a cloud platform comprising a primary node and a plurality of host nodes, wherein the method includes:
establishing an original configuration connection (OCC) with a host node to trigger a network configuration task for the host node;
upon receiving a task identifier (ID) assigned to a network configuration task, sending a new configuration connection (NCC) status query to the host node to monitor a status of the task;
upon detecting a status of completed for the network configuration task, sending a confirmation to the host node; and
responsive to receiving acknowledgement of the confirmation, generating a notification indicating configuration of the new network configuration.

2. The method of claim 1, further comprising:
responsive to the host node returning a status of failed in reply to the NCC status query for the network configuration task, sending a confirmation to the node agent; and
responsive to receiving an acknowledgement of the confirmation from the node agent, triggering an active rollback task for the host node to restore the original network configuration to the host node.

3. The method of claim 2, further comprising:
sending an OCC status query for the active rollback task to the host node; and
responsive to detecting successful completion of the rollback task, record failed status of the network configuration task and successful restoration of the original network configuration.

4. The method of claim 1, further comprising:
responsive to the host node not returning a task status before a timeout interval expires, sending an NCC node agent information query.

5. The method of claim 4, further comprising:
responsive to detecting node agent information successfully returned, record failed status of the network configuration task and successful restoration of the original network configuration.

6. The method of claim 1, wherein the host nodes comprise heterogeneous host nodes including one or more compute nodes, one or more storage nodes, and one or more hyperconverged nodes.

7. The method of claim 1, wherein the network configuration task comprises a task to change the network configuration of a management network for the host node.

8. The method of claim 7, wherein at least some portion of the management network comprises an L2 management network.

9. The method of claim 7, wherein at least some portion of the management network comprises an L3 management network.

10. The method of claim 1, wherein establishing an OCC with the host node comprises establishing an OCC with each of the plurality of host nodes in parallel.

11. An information handling system, comprising:
a central processing unit (CPU);
a system memory, coupled to the CPU, including processor executable program instructions that, when executed by the CPU, cause the system to perform a management method for a cloud platform comprising a primary node and a plurality of host nodes, wherein the method includes:
establishing an original configuration connection (OCC) with a host node to trigger a network configuration task for the host node;
upon receiving a task identifier (ID) assigned to a network configuration task, sending a new configuration connection (NCC) status query to the host node to monitor a status of the task;
upon detecting a status of completed for the network configuration task, sending a confirmation to the host node; and
responsive to receiving acknowledgement of the confirmation, generating a notification indicating configuration of the new network configuration.

12. The information handling system of claim 11, wherein the management method includes:
responsive to the host node returning a status of failed in reply to the NCC status query for the network configuration task, sending a confirmation to the node agent; and
responsive to receiving an acknowledgement of the confirmation from the node agent, triggering an active rollback task for the host node to restore the original network configuration to the host node.

13. The information handling system of claim 12, wherein the management method includes:
sending an OCC status query for the active rollback task to the host; and
responsive to detecting successful completion of the rollback task, record failed status of the network configuration task and successful restoration of the original network configuration.

14. The information handling system of claim 11, wherein the management method includes:
responsive to the host node not returning a task status before a timeout interval expires, sending an NCC node agent information query.

15. The information handling system of claim 14, wherein the management method includes:
responsive to detecting node agent information successfully returned, recording failed status of the network configuration task and successful restoration of the original network configuration.

16. The information handling system of claim 11, wherein the host nodes comprise heterogeneous host nodes including one or more compute nodes, one or more storage nodes, and one or more hyperconverged nodes.

17. The information handling system of claim 11, wherein the network configuration task comprises a task to change the network configuration of a management network for the host node.

18. The information handling system of claim 17, wherein at least some portion of the management network comprises an L2 management network.

19. The information handling system of claim 17, wherein at least some portion of the management network comprises an L3 management network.

20. The information handling system of claim 11, wherein establishing an OCC with the host node comprises establishing an OCC with each of the plurality of host nodes in parallel.
